(19) United States
(12) Patent Application Publication
(10) Pub. No.: US 2013/0288837 A1
(43) Pub. Date: Oct. 31, 2013

(54) METHOD AN APPARATUS FOR USE OF CHAIN

(71) Applicant: Pekka Tuomikoski, Rauma (FI)

(72) Inventor: Pekka Tuomikoski, Rauma (FI)

(73) Assignee: FINNCHAIN OY, Rauma (FI)

(21) Appl. No.: 13/996,006

(22) PCT Filed: Sep. 13, 2011
(86) PCT No.: PCT/FI2011/050783

§ 371 Date: Jun. 20, 2013

(30) Foreign Application Priority Data
Dec. 20, 2010 (FI) 20106342

(51) Int. Cl. F16H 7/06

(52) U.S. Cl. CPC F16H 7/06
USPC 474/148

(57) ABSTRACT

A method and apparatus for use of chain. The chain is formed of shaped pieces connected to each other one after another at jointing points in jointing parts existing at opposite ends thereof by joint pins. The chain is driven by a drive arrangement that includes at least one chain wheel. A deviation of a center line(s) defined by the chain's successive joint pins from a curvature of the drive wheels and/or the turning wheels supporting surface when the chain gets bent over the drive wheel and/or the turning wheel is minimized by using shaped pieces that have jointing parts that exist at a deviating angle with respect to the center line(s) thereof.

The invention relates to a method and apparatus for use of chain according to the preambles of the independent claims.

Regarding a traditional chain structure, wherein power transmission of a chain structure is usually transmitted by a drive wheel, the shape of the teeth of which is standardized, a more developed chain structure is previously known e.g. from Finnish patents FI 64707 and FI 101098. The supporting surface of the chain represented in these patents comprises notches existing crosswise in respect to the moving direction to the chain, the notches being during conveying of the chain in cooperation with counterpart surfaces, such as pins or like belonging to the chain wheel. The shaped pieces forming the chain comprise a notch existing crosswise in respect to the moving direction of the chain, the length of the notch corresponding to the width of the shaped piece and being advantageously placed near one of the jointing points of the shaped piece. In this case, when the chain gets bent over the drive wheel, an advantageous lever arm is achieved, thanks to which the chain force influencing the chain structure presses the notches of the chain harder against the pins of the drive wheel. This solution decreases significantly so called skipping. Also thanks to the level arms being formed, the chain structure gets easily loose from the drive wheel on its return side thanks to which a so called non-engagement of the chain is prevented.

The chain structure according to Patent FI 64707 has proved to be significantly better than corresponding earlier solutions, particularly thanks to the lever arms being achieved. In certain purposes, such as in chain structures being used in water refineries, plastics or corresponding non-metallic materials have been exploited because of corrosion and in order to decrease the specific gravity of the chain. In this case, in certain applications there has been found problems, that are caused due to bending forces directed to the chain in the level corresponding the joint pins e.g. because of natural bending of the chain when the chain is being used in such position, that the joint pins are in a vertical position. Due to this, during cooperation between ordinary straight joint pins and corresponding straight counterpart surfaces existing in the shaped pieces, even a small angular alteration causes always that, that the counterpart surfaces of successive shaped pieces are in contact with each other only by one edge thereof. This naturally causes wearing of both the joint pins and the counterpart surfaces, because the surface pressures are very high e.g. when the chain starts to move in such a bent situation as described above.

In patent FI 101098 there has been presented an improvement for the problem above, which is based on that, that bending of the chain essentially along the longitudinal direction of the joint pins is being minimized by taken advantage of joint pins, the cross section of which increases towards one end thereof. When exploiting furthermore advantageously e.g. joint pins, that are continuously conical, the surface pressures may be optimized under all circumstances in a way, that the type of bending of the chain may be even totally eliminated in principle. In addition to that, by exploiting the type of joint pins even mounting of the chain may be eased by the guiding influence of the conical joint pin.

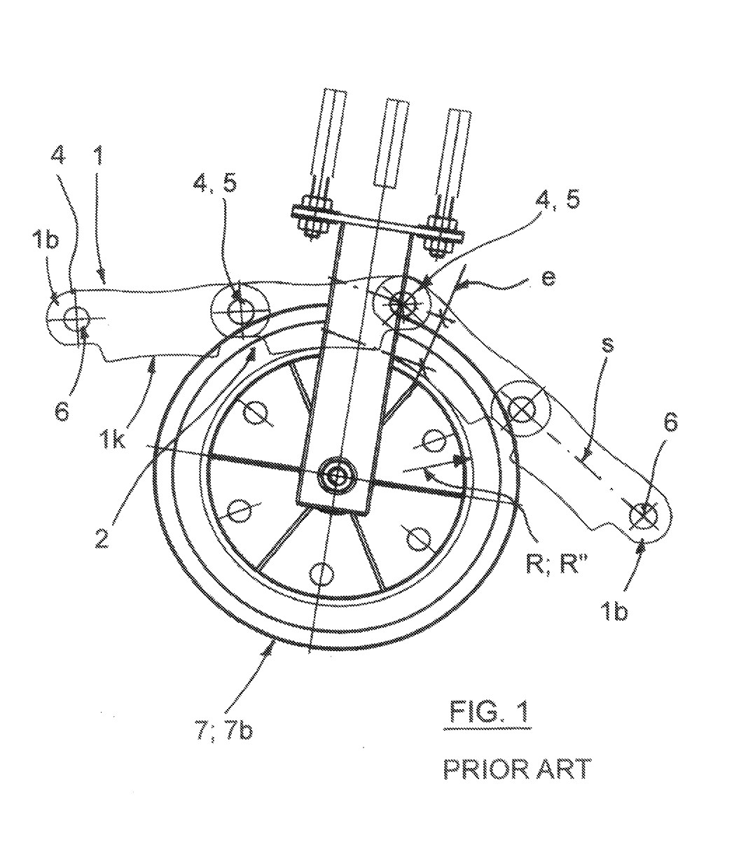

Regarding the very developed as such chain structure described above, there has been, however, found a possibility to improve functioning of the chain particularly when the chain gets bent over a drive wheel or a turning wheel. As can be seen from the enclosed FIG. 1 presenting prior art, the jointing points between successive formed pieces of the chain raise rather far away from the supporting surface e.g. of a turning wheel, when the chain gets bent over the same. In use of the chain, this causes e.g. thanks to friction and the like reasons vibration due to the fact that the formed pieces tend to, so to say, swing particularly when it is been driven by a drive wheel. In certain operating speeds of the chain, this may even cause resonance.

It is an aim of the method and apparatus according to the present invention to achieve a decisive improvement in the problems presented above and thus to raise substantially the level of knowledge in the field. To achieve this aim, the method and apparatus according to the invention are primarily characterized by what has been presented in the characterizing parts of the independent claims related thereto.

As the most important advantages of the method and apparatus according to the invention may be mentioned simplicity and reliability of the use and construction of the chain enabled by the same, in which case thanks to the chain vibration being prevented, it is possible to increase remarkably the lifetime of a whole chain drive apparatus. This is due to the fact that a contact surface of mutual supporting surfaces of successive formed pieces forming the chain and a turning wheel or a drive wheel can be efficiently expanded in a way that the jointing points do not cause vibration due to momentum in a corresponding manner as in earlier solutions. The invention is based on shaped pieces that deviate as such in a surprising manner from traditional chain solutions thanks to the jointing parts thereof, being at a deviating angle with respect to the center line defined by the joint pins of the formed pieces. The jointing parts according to the invention enable positioning of the shaped pieces in a wider area over the supporting surface of a turning wheel or a drive wheel than in traditional solutions that is almost by the whole length thereof thanks to the mutual curvatures being united significantly better than in earlier solutions. In the method and apparatus according to the invention there has been exploited furthermore advantageously e.g. continuously conical joint pins according to the patent FI 101098, which for their part furthermore simultaneously minimize the bending of the chain.

Advantageous embodiments of the method and apparatus according to the invention are represented in the dependent claims related thereto.

In the following description, the invention is illustrated in detail with reference to the appended drawings, wherein

FIG. 1 shows as a view from above the bending of a chain according to prior art over a turning wheel,

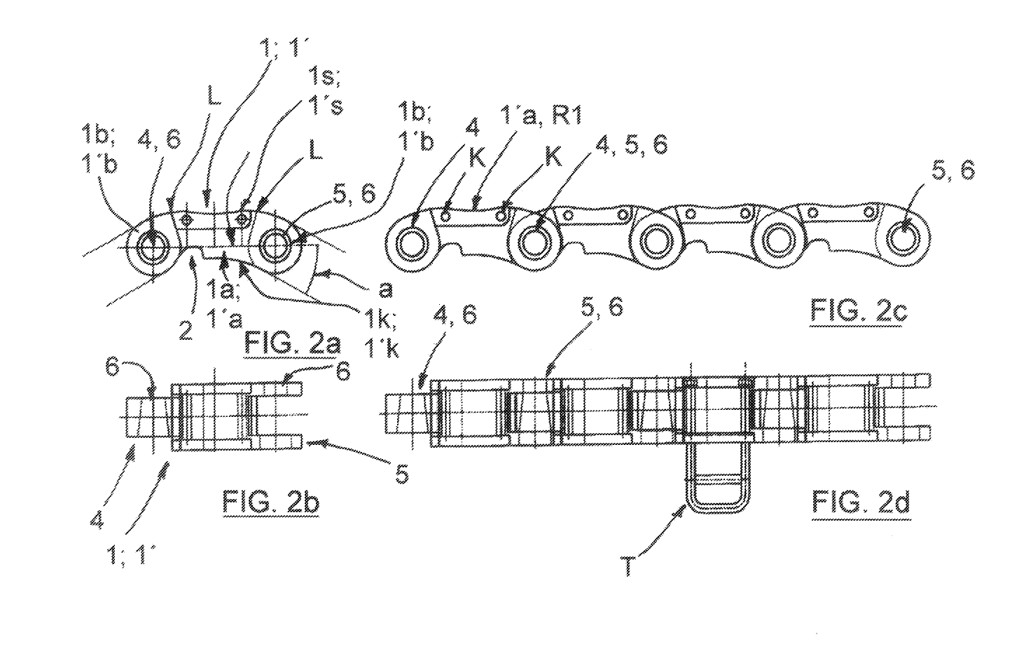

FIGS. 2a-2d show in pairs as a view from above and as a side view a single formed piece of a chain operating according to the invention (FIGS. 2a and 2b) and a chain, being formed of corresponding formed pieces (FIGS. 2c and 2d),

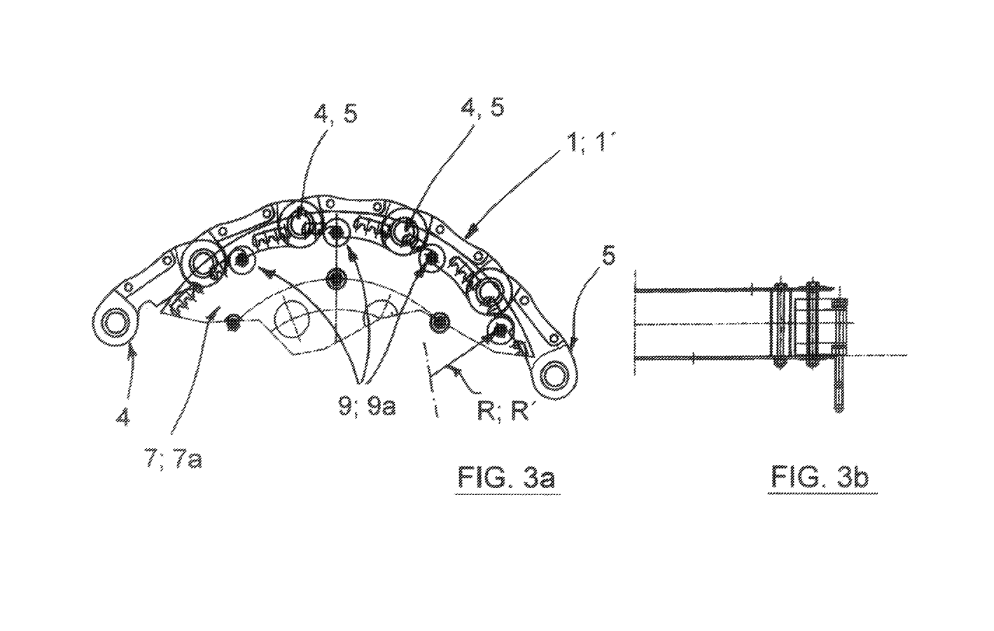

FIGS. 3a and 3b show as a view from above the bending of a chain according to the invention over a drive wheel and a cross section along line 3b-3b from FIG. 3a,

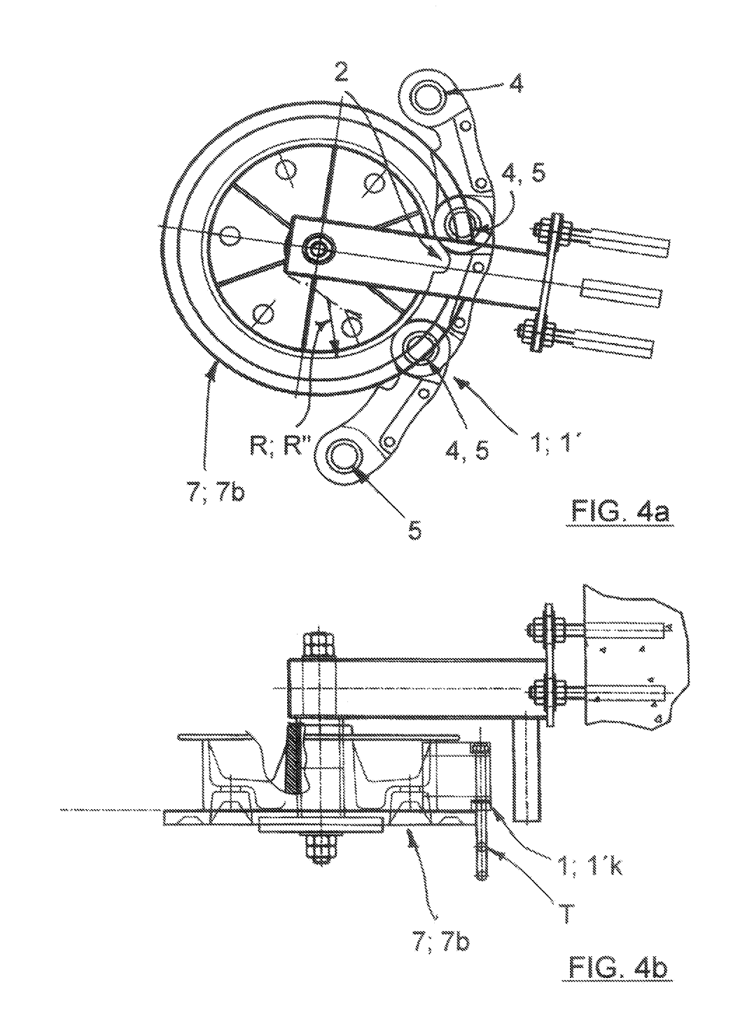

FIGS. 4a and 4b show as a view from above and as a side view the bending of a chain according to the invention over a turning wheel,

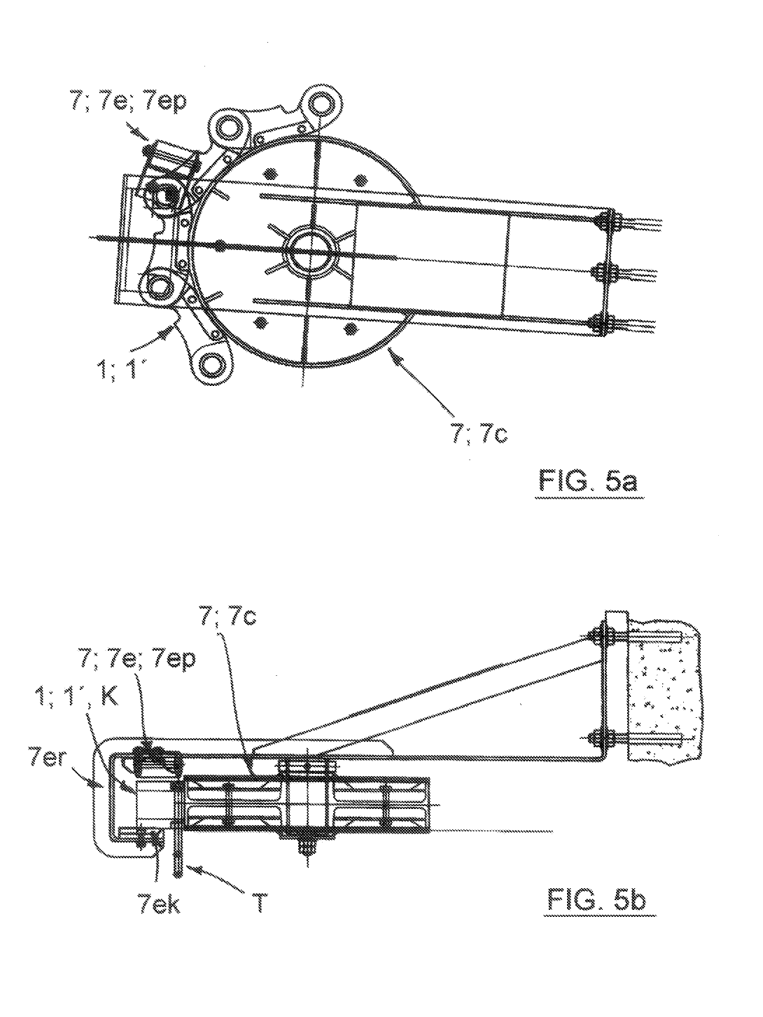

FIGS. 5a and 5b show as a view from above and as a side view the functioning of a chain according to the invention in connection with a guide wheel that has been advantageously exploited in the invention,

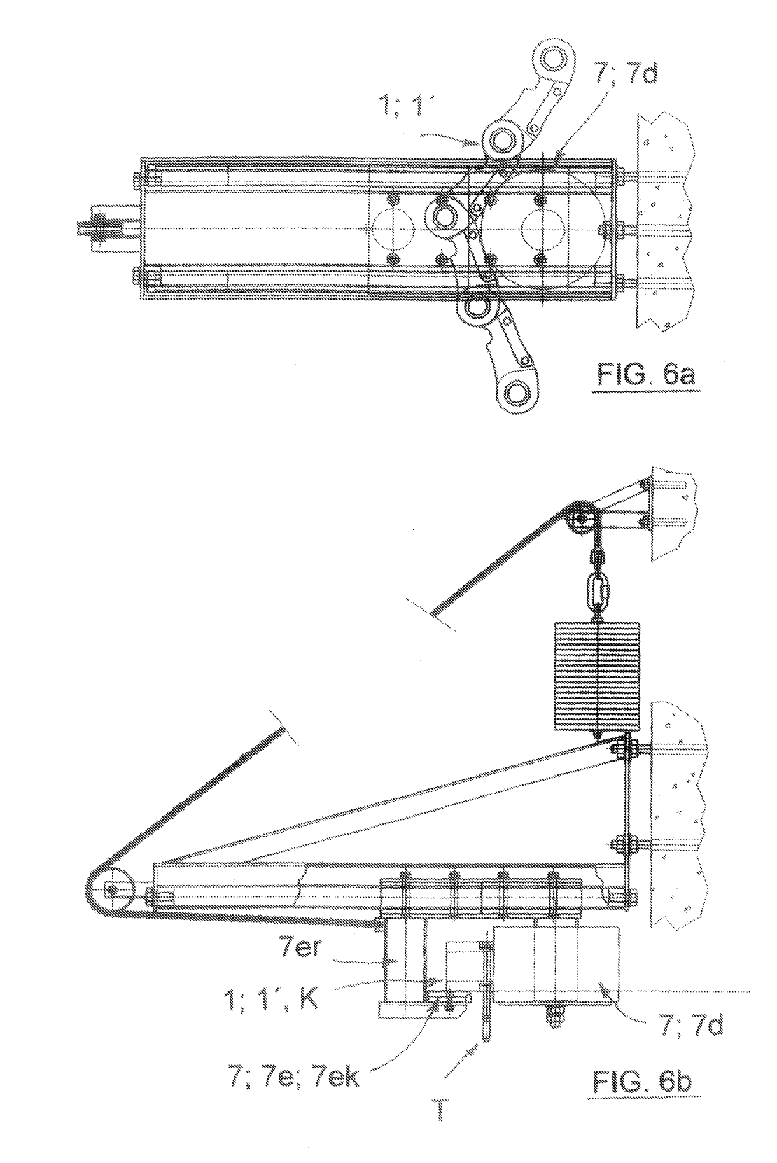

FIGS. 6a and 6b show as a view from above and as a side view functioning of a chain according to the invention in connection with a chain tightening device that has been advantageously exploited in the invention,

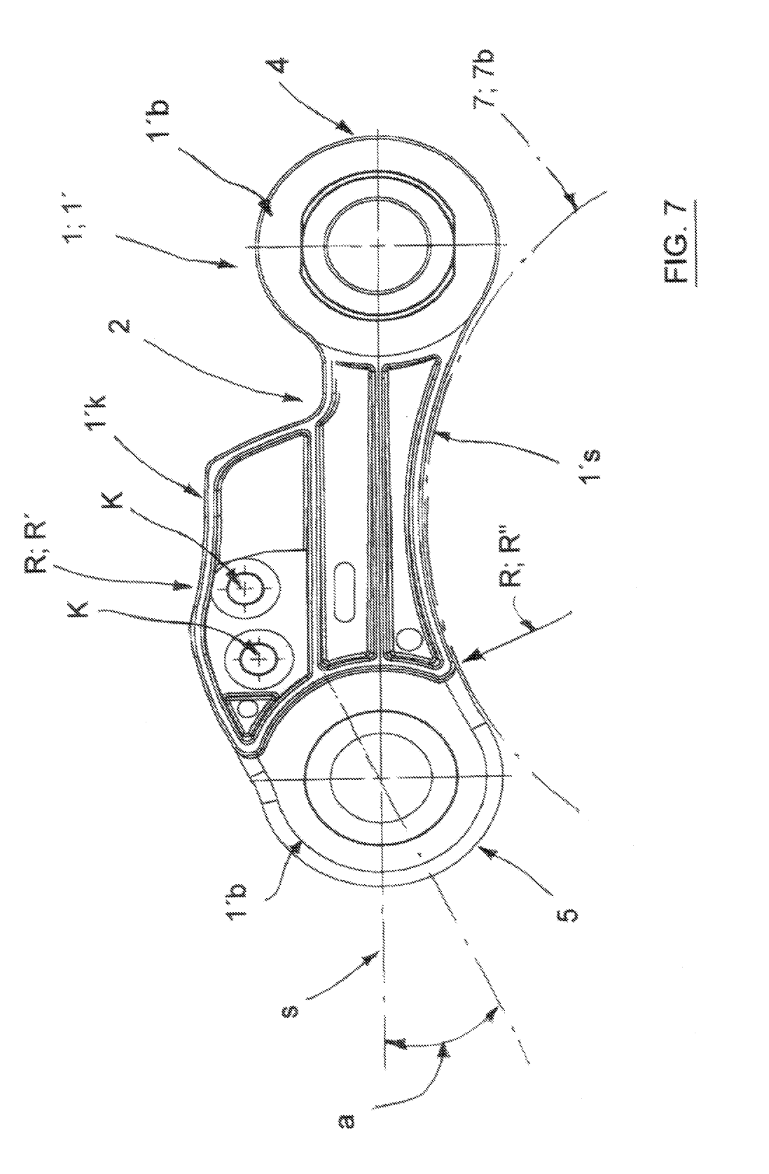

In FIG. 7 is shown as a side view an advantageous shaped piece being an alternative to the solution shown e.g. in FIG. 2a, and

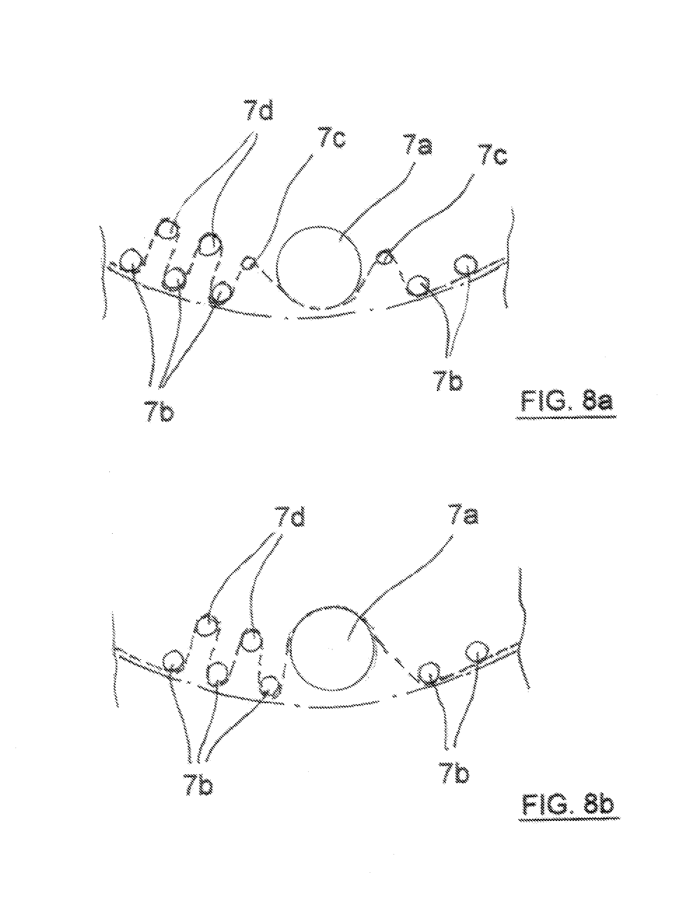

In FIGS. 8a and 8b are shown two alternative chain lines in connection with a drive wheel.

The invention relates to a method for use of chain, wherein the chain, such as a transmission chain, conveyor chain and/or like, is formed of shaped pieces 1, being connected to each other one after another at jointing points 4, 5 in jointing parts 1b, existing at opposite ends of the shaped pieces, by means of joint pins, whereby in order to form the jointing points 4, 5 of the chain, a first jointing point in the jointing parts 1b of each shaped pieces 1 is arranged as a uniform projection 4 that is essentially narrower than the width 1 of the shaped piece, and a second one as a fork 5. Within both of the jointing points 4, 5 there exist holes 6, in which case in order to form a chain, each jointing point 4, 5 is to be formed by placing the said projection 4 of a previous shaped piece between the fork 5 of a following shaped piece and by placing a joint pin in the hole 6 (in FIGS. 2c and 2d the joint pins have not, however, been illustrated). The chain is being driven by means of a drive arrangement, which includes at least one chain wheel 7, such as a drive wheel, a turning wheel or like, whereby, with reference to FIG. 1 showing the level of prior art, supporting surfaces 1k existing in middle parts 1a of the shaped pieces 1 forming the chain comprise notches 2 that are arranged essentially crosswise in respect to the moving direction of the chain and that are during conveying of the chain in cooperation with counterpart surfaces 9, such as, e.g. according to FIGS. 3a and 3b, pins 9a belonging to the chain wheel 7 and being arranged according to the notches 2a and essentially crosswise in respect to the moving direction of the chain. A deviation of a center line s defined by the chain's successive joint pins from a curvature R; R′, R″ of the drive wheel's and/or the turning wheel's 7a, 7b supporting surface, when the chain gets bent over a drive wheel and/or a turning wheel, is being minimized by using, with reference to the advantageous embodiments as shown in FIGS. 2a-2d and 7, shaped pieces 1; 1′, which have jointing parts 1′b that exist at a deviating angle a with respect to the center line s thereof.

As an advantageous embodiment of the method e.g. with reference to FIGS. 2a-2d and 7, shaped pieces 1; 1′ are advantageously being used in the chain, in which the supporting and back surfaces 1′k, 1′s of the middle parts 1′a thereof join with corresponding surfaces of the jointing parts 1′b with arched joint surfaces L or tangentially.

The deviation e of jointing points 4, 5 of shaped pieces 1 in a chain according prior art particularly as shown in FIG. 1 from a drive wheel's or a turning wheel's support surface can be significantly decreased when applying the method according to the invention, which can be clearly seen by comparing the functioning of the chain according to prior art, as shown in FIG. 1, to the bending of the chain according to the invention, e.g. as shown in FIGS. 3a, 4a and 7, when the same gets bent over a turning wheel or a drive wheel.

The invention relates also to an apparatus for use of chain, the apparatus having a chain, such as a transmission chain, conveyor chain and/or like that is formed of shaped pieces 1, being connected to each other one after another at jointing points 4, 5 in jointing parts 1b, existing at opposite ends of the shaped pieces, by means of joint pins, whereby supporting surfaces 1k existing in middle parts 1a of the shaped pieces 1 comprise, in the same way as in the implementation according to prior art, as shown e.g. in FIG. 1, notches 2 that are arranged essentially crosswise in respect to the moving direction of the chain and that are during conveying of the chain in cooperation with counterpart surfaces 9, such as pins 9a or like belonging to the chain wheel 7 and being arranged according to the notches 2a and essentially crosswise in respect to the moving direction of the chain, and a drive arrangement, which comprises at least one chain wheel 7, such as a drive wheel, a turning wheel or like, whereby in order to form the jointing points 4, 5 of the said chain, a first jointing point in the jointing parts 1b of each shaped piece 1 is arranged as a uniform projection 4 that is essentially narrower than the width 1 of the shaped piece, and a second one as a fork 5. Within both of the jointing points 4, 5 there exist holes 6, in which case in order to form a chain, each jointing point 4, 5 is to be formed by placing the said projection 4 of a previous shaped piece between the fork of a following shaped piece and by placing a joint pin in the hole 6. The jointing parts 1′b in the shaped pieces 1; 1′ forming the chain are arranged according to the advantageous embodiments as shown e.g. in FIGS. 2a-2d and 7 at a deviating angle a with respect to a center line s defined by the successive joint pins thereof, in order to minimize deviation of the center line s of the chain that gets bent over a drive wheel and/or a turning wheel from a curvature R; R′, R″ of a drive wheel's and/or a turning wheel's 7a, 7b supporting surface.

As an advantageous embodiment of the chain according to the invention, the supporting and back surfaces 1′k, 1′s in the middle parts 1′a of the shaped pieces 1; 1′ forming the chain join with corresponding surfaces of the jointing parts 1′b with arched joint surfaces L or tangentially on the principle manifesting itself e.g. from FIGS. 2a and 7.

In FIG. 8a there has been presented a typical chain line in the use of a chain that is formed of shaped pieces as shown e.g. in FIG. 2a, wherein the jointing parts 1′b are arranged to be directed to the side of the shaped piece 1; 1′ with the supporting surfaces 1′k. In this case, passage of the chain is guided first of all by turning wheels 7b in connection with the basin walls by keeping it tightened with tightening wheels 7d. The chain is being guided onto the drive wheels 7a by using guide wheels 7c on opposite sides thereof. This is due to the fact that thanks to the formation of the back surface of the type of shaped piece as shown e.g. in FIG. 2a, it is most profitably transported over the drive wheels and the turning wheels 7a, 7b on its supporting surface 1′k.

In FIG. 7 there has been presented instead a shaped piece deviating from the shaped piece shown e.g. in FIG. 2a, in which the jointing parts 1′b are arranged to be directed to the side of the shaped piece 1; 1′ with the back surface 1′s. In this case, the shaped piece is aimed to enable, thanks to the stronger curvature of its back surface 1′s, particularly a type of the chain line in connection with a drive wheel as shown e.g. in FIG. 8b, wherein the chain formed of the shaped pieces in question makes possible conveying of the chain by exploiting its back and supporting surfaces 1′s, 1′k or in other words, in connection with the turning wheels 7b by the basin edges on its back surface and in connection with the drive wheel 7a naturally on its supporting surface 1′k. In this way, an implementation according to FIG. 8b, deviating from the implementation of FIG. 8a, is made possible, in which separate guide wheels 7c need not be exploited in connection with the drive wheel 7a, but instead the chain can be guided directly from the turning wheels 7b onto the same, whereby the angle of the contact surface between the chain and the drive wheel can be even widened.

The curvature of the back surface of the shaped piece 1; 1′ is arranged as presented in FIG. 7 advantageously to correspond essentially to the curvature R; R″ of the turning wheel 7; 7b.

As a further advantageous embodiment of the chain belonging to the apparatus according to the invention, the back surface 1′s of the middle part 1′a of the shaped piece 1′ belonging to the chain, is thus arranged arched R1. Furthermore as a further advantageous embodiment, the shaped pieces are provided with fastening means K for coupling of actuator means T to be attached to the chain.

As shown particularly in FIGS. 2a and 7, the notch 2 of a shaped piece 1′ belonging to the chain, is arranged to join tangentially with the jointing part thereof 1′b, 4. This enables optimum functioning of the chain in connection with both the drive wheel 7a and the turning wheels or e.g. the guide wheels 7b, 7c as shown e.g. in FIGS. 3a, 3b and 7, wherein thanks to the totally “arched” shape of the chain's shaped pieces 1′, they get pressed in an optimized manner against the drive wheel's drive pins and the periphery of the turning wheel or the guide wheel.

Furthermore as an advantageous embodiment particularly with reference to FIGS. 5a, 5b and 6a, 6b, the drive arrangement comprises a guide wheel 7c and a tightening device 7d that are in contact with the back surface 1′s of the shaped pieces 1′ forming the chain. The guide wheel 7c is being used as explained earlier when needed e.g. when the passage of the chain onto a turning wheel or a drive wheel is being guided. Respectively, the tightening device 7d, functioning e.g. on counterbalance principle according to FIG. 6b, is being used for keeping the chain tight along with wearing thereof. For the same purpose in the advantageous embodiment shown in FIG. 3a, there has been exploited a drive wheel 7a that is provided with drive pins 9a, the mutual distance of the pins being adjustable in order to compensate wearing of the chain by fine adjusting placement of the joint pins of the drive wheel.

As a further advantageous embodiment, the drive arrangement 7 also discloses particularly with reference to FIGS. 5a and 5b an assembly 7e that guides passage of the chain, which comprises one or more press rolls 7ep with plain bearing for adjusting passage height of the chain. This type of a guide can be exploited for guiding passage of a chain e.g. on the principle shown in FIG. 5a. Particularly with reference to the side views shown in FIGS. 5b and 6b, the guide assembly 7e comprises a slide piece 7ek that is fastened in a frame 7er, which extends on opposite side of the chain with respect to a fastening point of the guide presented in the drawings, which for its part also guides passage of the chain. The slide piece is arranged advantageously as a replaceable wearing piece. Correspondingly the press roll can be arranged to be pressed against the chain e.g. by an adjustable spring force or by gravitation.

It is clear that the invention is not limited to the embodiments presented or described above, but instead it can be modified even to a great extent depending on the operating environment at any given time. It is thus first of all clear that the drive notches in the shaped pieces can be placed in a deviating manner in respect with what has been presented above e.g. in connection with a, so to say, driving jointing part of the shaped piece or in a more centralized manner on the middle part of the supporting surface of the shaped piece. In the invention, it is thus possible and advantageous to exploit a conical joint pin known as such from earlier chain solutions in the jointing parts of the successive shaped pieces, in which context it might be possible also to use in the successive jointing points of the shaped pieces joint pins that expand in opposite directions. It is also possible to manufacture the joint pins e.g. from suitable materials in a way that in the joint pins there are projection arrangements ready that enable some kind of a snap locking etc.

1. Method for use of chain, wherein the chain, such as a transmission chain, conveyor chain and/or like, is formed of shaped pieces (1), being connected to each other one after another at jointing points (4, 5) in jointing parts (1b), existing at opposite ends of the shaped pieces, by means of joint pins, whereby in order to form the jointing points (4, 5) of said chain, a first jointing point in the jointing parts (1b) of each shaped pieces (1) is arranged as a uniform projection (4) that is essentially narrower than the width (l) of the shaped piece, and a second one as a fork (5), whereby within both of the jointing points (4, 5) there exist holes (6), in which case in order to form a chain, each jointing point (4, 5) is to be formed by placing the said projection (4) of a previous shaped piece between the fork (5) of a following shaped piece and by placing a joint pin in the hole (6), and, whereby the chain is being driven by means of a drive arrangement, which includes at least one chain wheel (7), such as a drive wheel, a turning wheel or like, whereby supporting surfaces (1k) existing in middle parts (1a) of the shaped pieces (1) comprise notches (2) that are arranged essentially crosswise in respect to the moving direction of the chain and that are during conveying of the chain in cooperation with counterpart surfaces (9), such as pins (9a) or like belonging to the chain wheel (7) and being arranged according to the notches (2a) and essentially crosswise in respect to the moving direction of the chain, characterized in that a deviation of a center line (s) defined by the chain's successive joint pins from a curvature (R; R′, R″) of the drive wheel's and/or the turning wheel's (7a, 7b) supporting surface, when the chain gets bent over a drive wheel and/or a turning wheel, is being minimized by using shaped pieces (1; 1′), which have jointing parts (1′b) that exist at a deviating angle (a) with respect to the center line (s) thereof.

2. Method according to claim 1, characterized in, that in the chain shaped pieces (1; 1′) are being used, in which the supporting and back surfaces (1′k, 1′s) of the middle parts (1′a) thereof join with corresponding surfaces of the jointing parts (1′b) with arched joint surfaces (L) or tangentially.

3. Apparatus for use of chain, having a chain, such as a transmission chain, conveyor chain and/or like, is formed of shaped pieces (1), being connected to each other one after another at jointing points (4, 5) in jointing parts (1b), existing at opposite ends of the shaped pieces, by means of joint pins, whereby in order to form the jointing points (4, 5) of the chain, a first jointing point in the jointing parts (1b) of each shaped piece (1) is arranged as a uniform projection (4) that is essentially narrower than the width (l) of the shaped piece, and a second one as a fork (5), whereby within both of the jointing points (4, 5) there exist holes (6), in which case in order to form a chain, each jointing point (4, 5) is to be formed by placing the said projection (4) of a previous shaped piece between the fork of a following shaped piece and by placing a joint pin in the hole (6), and a drive arrangement, which includes at least one chain wheel (7), such as a drive wheel, a turning wheel or like, whereby supporting surfaces (1k) existing in middle parts (1a) of the shaped pieces (1) comprise notches (2) that are arranged essentially crosswise in respect to the moving direction of the chain and that are during conveying of the chain in cooperation with counterpart surfaces (9), such as pins (9a) or like belonging to the chain wheel (7) and being arranged according to the notches (2a) and essentially crosswise in respect to the moving direction of the chain, characterized in that jointing parts (1′b) in shaped pieces (1; 1′) forming the chain are arranged at a deviating angle (a) with respect to a center line (s) defined by the successive joint pins thereof, in order to minimize deviation of the center line (s) of the chain that gets bent over a drive wheel and/or a turning wheel from a curvature (R; R′, R″) of the drive wheel's and/or the turning wheel's (7a, 7b) supporting surface.

4. Apparatus according to claim 3, characterized in that, the supporting and back surfaces (1′k, 1′s) in the middle parts (1′a) of the shaped pieces (1; 1′) forming the chain, join with corresponding surfaces of the jointing parts (1′b) with arched joint surfaces (L) or tangentially.

5. Apparatus according to claim 3 or 4, characterized in that, the jointing parts (1′b) are arranged to be directed to the side of the shaped piece (1; 1′) with the supporting surfaces (1′k).

6. Apparatus according to claim 3 or 4 above, characterized in that, the jointing parts (1′b) are arranged to be directed to the side of the shaped piece (1; 1′) with the back surface (1′s).

7. Apparatus according to any of the preceding claims 3-6, characterized in that, the back surface (1′s) of the middle part (1′a) of the shaped piece (1′) belonging to the chain, is arranged arched (R1).

8. Apparatus according to any of the preceding claims 3-7, characterized in that, the notch (2) of a shaped piece (1′) belonging to the chain, is arranged to join tangentially with the jointing part thereof (1′b, 4).

9. Apparatus according to any of the preceding claims 3-8, characterized in that, the drive arrangement comprises a guide wheel (7c) and/or a tightening device (7d) that is/are in contact with the back surface (1′s) of the shaped pieces (1′) forming the chain.

10. Apparatus according to any of the preceding claims 3-9, characterized in that, the drive arrangement comprises an assembly (7e) that guides passage of the chain, such as one or more press rolls (7ep), slide pieces (7ek) and/or like.
